(19) United States
(12) Patent Application Publication
(10) Pub. No.: US 2009/0014977 A1
(43) Pub. Date: Jan. 15, 2009

(54) CONTROL ARM FOR VEHICLES

(76) Inventor: Kelly J. Molenaar, Kalamazoo, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/104,837

(22) Filed: Apr. 17, 2008

Related U.S. Application Data
(60) Provisional application No. 60/948,854, filed on Jul. 10, 2007.

(51) Int. Cl. B60G 3/06

(52) U.S. Cl. 280/124.134

(57) ABSTRACT

A control arm for vehicle suspensions includes an arm structure having first and second elongated portions that extend from a central portion to form a U or V shaped structure. The arm structure includes a spindle mount at the central position for mounting a spindle. A cross member extends between the first and second elongated portions, and one or more self-aligning ball bearings pivotably interconnect the arm structure to the cross member.

### CROSS-REFERENCE TO RELATED APPLICATIONS

This application claims the benefit of U.S. Provisional Patent Application No. 60/948,854, filed on Jul. 10, 2007, the entire contents of which are incorporated herein by reference.

### BACKGROUND OF THE INVENTION

Known suspension systems for vehicles may include a control arm 1 (FIG. 1) including a weldment 2 with front and rear extensions 3 and 4, respectively and a mount 5 that is configured for mounting a ball joint to pivotably support a spindle. A cross shaft 6 is pivotably mounted to short pieces of tubing 7 and 8 that are welded to the ends of front and rear extensions 3 and 4, respectively. Openings 9 and 10 in cross shaft 6 provide for mounting the control arm 1 to a vehicle frame structure or the like utilizing conventional threaded fasteners or other suitable connectors. Grease fittings 11 and 12 provide for injection of grease or the like to lubricate the pivoting connection between the cross shaft 6 and the pieces of tubing 7 and 8.

Known control arms may suffer from various drawbacks. For example, the pieces of tubing 7 and 8 may warp or otherwise become misaligned during the welding process, such that the cross shaft 6 does not rotate freely within the pieces of tubing 7 and 8. Also, when the vehicle suspension system is experiencing high load (e.g., during heavy braking) the front and rear extensions 3 and 4, respectively, will deflect somewhat, and this deflection may cause binding at the pivotal interconnection between the cross shaft 6 and the pieces of tubing 7 and 8. Still further, the bearing surfaces between the cross shaft 6 and pieces of tubing 7 and 8 may not be sealed, such that dirt and the like may enter the bearing area and affect the ability of the weldment 2 to pivot freely relative to the cross shaft 6.

Accordingly, a suspension control arm alleviating the problems associated with existing control arms would be advantageous.

### BRIEF DESCRIPTION OF THE DRAWINGS

FIG. 1 is an isometric view of a prior art control arm;

FIG. 2 is a partially fragmentary isometric view of a vehicle frame structure including a suspension system having a control arm according to one aspect of the present invention;

FIG. 3 is an exploded isometric view of a control arm according to one aspect of the present invention;

FIG. 4 is a front elevational view of a suspension control arm according to one aspect of the present invention;

FIG. 5 is a top plan view of the suspension control arm of FIG. 4;

FIG. 6 is a cross-sectional view of the control arm taken along the line VI-VI; FIG. 5; and

FIG. 7 is a partially fragmentary enlarged view of a portion of the suspension arm assembly of FIG. 6.

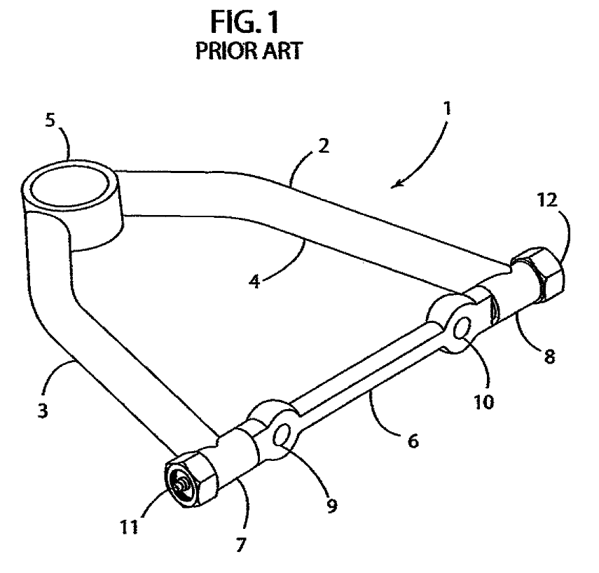

### DETAILED DESCRIPTION OF PREFERRED EMBODIMENT

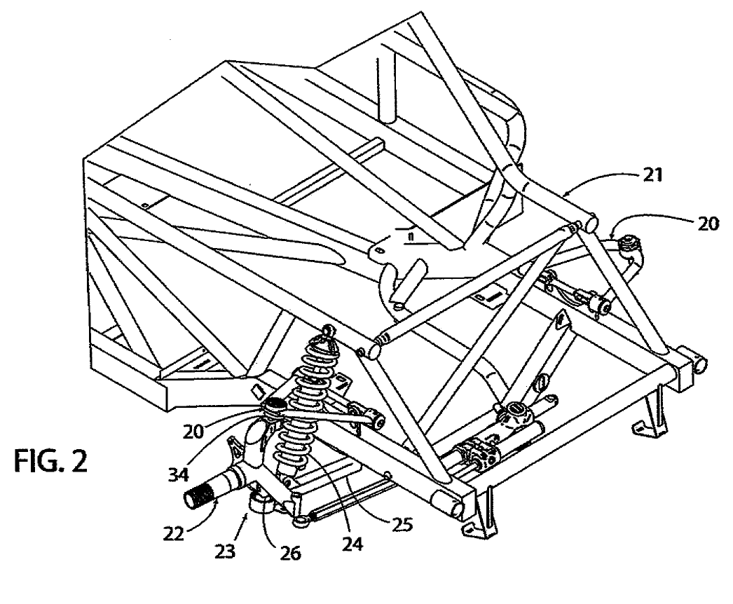

For purposes of description herein, the terms “upper, ” “lower,” “right,” “left,” “rear,” “front,” “vertical,” “horizontal,” and derivatives thereof shall relate to the invention as oriented in FIG. 2. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference to FIG. 2, a suspension arm assembly 20 according to the present invention is mounted to a vehicle frame 21 to thereby interconnect a spindle 22 of the vehicle suspension 23. In an illustrated example, the vehicle frame 21 comprises a plurality of tubes that are welded together to form a rigid structure suitable for use in a race car or the like. However, it will be apparent that the suspension arm 20 of the present invention may be utilized in a wide variety of vehicles, and is therefore not limited to use in race cars and the like. A link 25 is interconnected to a lower ball joint 26 of spindle 22, and a coil over spring and shock assembly 24 provides biasing and dampen force for the vehicle suspension in a known manner.

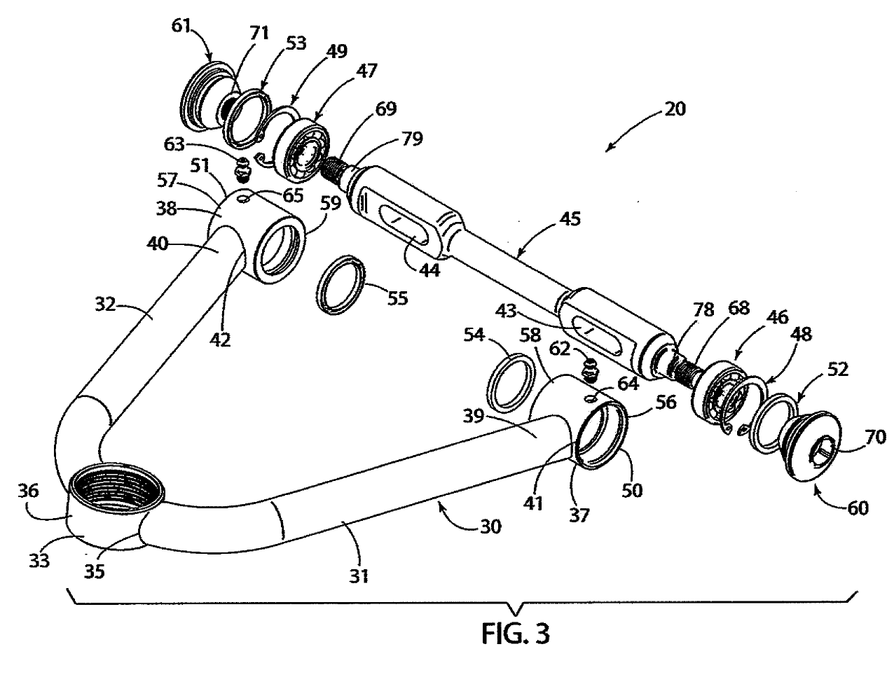

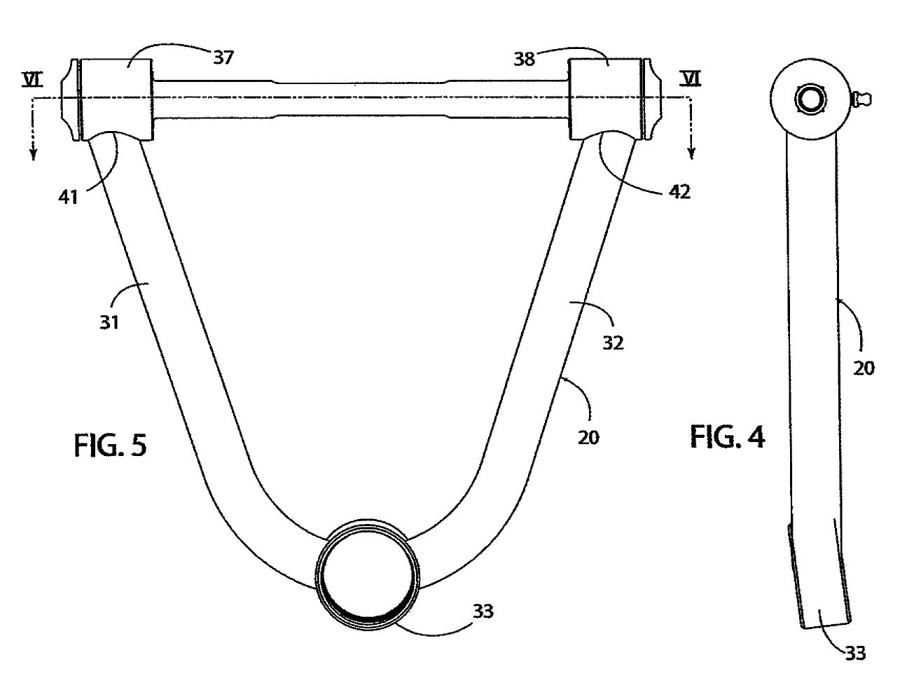

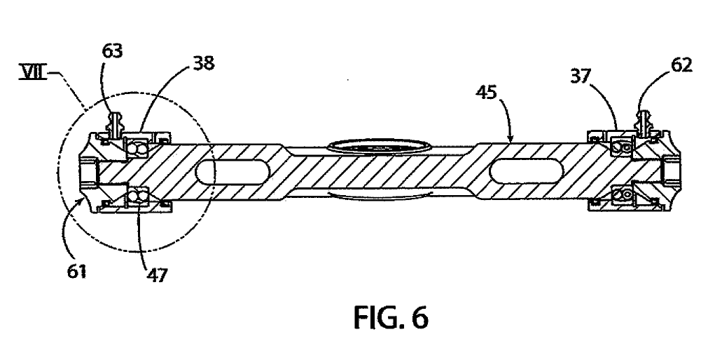

With further reference to FIGS. 3-5, a suspension arm assembly 20 according to the present invention includes a weldment 30 including a front and rear tubes 31 and 32, respectively, that are welded to a mount 33 at weld joints 35 and 36, respectively, that secures the suspension arm assembly 20 to a ball joint 34 (FIG. 2) that is connected to a spindle 22. Front and rear housings 37 and 38, respectively are welded to ends 39 and 40 of front and rear tubes 31 and 32, respectively at weld joints 41 and 42, respectively.

A cross shaft 45 is pivotably mounted to the weldment 30 by front and rear angularly misaligning ball bearings 46 and 47, respectively. As discussed in more detail below, the angularly misaligned ball bearings 46 and 47 may be commercially available bearings having inner and outer races that can be misaligned relative to one another, yet still rotate freely. When assembled, retaining rings 48 and 49 are received in annular grooves 50 and 51 of housings 37 and 38, respectively to retain the bearings 46 and 47. Elastomeric seals 52, 53, 54 and 55 are received in the open ends 56, 57, 58 and 59, respectively of front and rear housings 37 and 38, respectively, and, along with end caps 60 and 61, seal off the housings 37 and 38. Grease fittings 62 and 63 are received in threaded openings 64 and 65 of housings 37 and 38, respectively to provide for injection of grease into the housings 37 and 38 to lubricate the bearings 47 and 48.

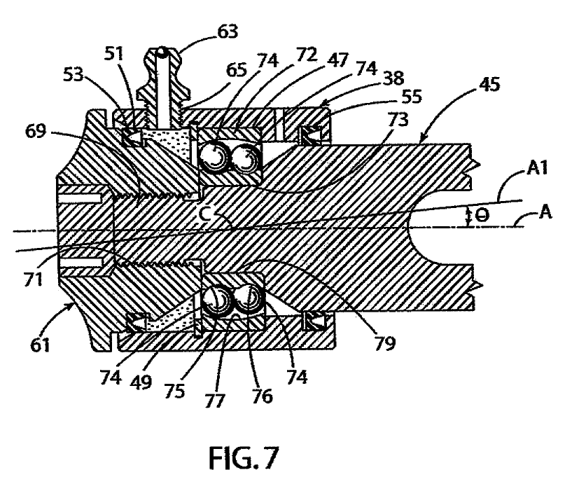

With further reference to FIG. 7, threaded end 69 of cross shaft 45 threadably engages a threaded opening 71 of end cap 61 to thereby retain the cross shaft 45 to the housing 38 and also to retain the seals 53, 55, and the angularly misaligned ball bearing 47. It will be understood that the threaded end 68 (FIG. 3) of cross shaft 45 similarly engages threaded opening 70 of end cap 60. The angularly misaligned ball bearings 46 and 47 each include an outer race 72 and an inner race 73 and a plurality of spherical rolling elements such as balls 74 disposed between the inner and outer races 73 and 72, respectively. The inner race 73 includes a pair of outwardly facing grooves 75 and 76 that receive the rolling element 74, and the outer race 72 includes an inwardly-facing curved surface 77 that also engages the rolling element 74. The outer race 72 is closely received in the housing 38, and therefore moves with the housing 38. The inner race 73 is closely received around cylindrical surface 79 of cross shaft 45, and therefore moves with the cross shaft 45. The combination of the grooves 75 and 76 of inner race 73 and curved surface 77 of outer race 72 permits the axis “A1” of the inner race 73 to rotate somewhat about a center point “C” relative to the axis “A” of outer race 72 without causing binding or the like as the weldment 30 rotates about the cross shaft 45. The maximum allowable angle θ depends upon the specific design of the bearings 47 and 48. In general, the angle θ may be relatively large, in the range of 5°-10° or more. The angularly misaligning bearings 46 and 47 may be of a commercially available type. In the illustrated example, the bearings 46 and 47 are SKF Part No. 1202 ETN9 self-aligning bearings. However, other types of angularly misaligning bearings may also be utilized.

With reference back to FIG. 3, cross shaft 45 includes a pair of slots 43 and 44 that receive threaded fasteners or the like to mount the cross shaft 45 to a vehicle structure such as the vehicle frame 21 (FIG. 2). The angularly misaligned ball bearing arrangement of the suspension arm assembly 20 provides for free rotation of the weldment 30, even during highly loaded conditions occurring during vehicle operation. Furthermore, the bearings are sealed in the housings, and therefore are not exposed to the dirt or the like that could otherwise interfere with operation of the suspension arm assembly. The suspension arm assembly 20 can be readily assembled, and warpage due to welding or the like does not lead to binding or the like between the cross shaft 45 and weldment 30.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A control arm assembly for a motor vehicle suspension, comprising:
a substantially rigid arm structure having a central portion configured to attach to a spindle, and front and rear portions extending from the central portions and defining first and second end portions, respectively;
a cross member configured to be mounted to a vehicle frame structure, the cross member extending between the first and second end portions;
first and second angularly misaligning ball bearings pivotably interconnecting the front and rear portions, respectively, of the rigid arm structure to the cross member at spaced-apart locations and defining a pivot axis about which the arm structure pivots relative to the cross member; and wherein:
the first and second angularly misaligning ball bearings each include an outer race, an inner race, and a plurality of rolling bearing elements movably engaging the inner and outer races, and wherein the inner race rotates about a first axis and the outer race rotates about a second axis, and wherein the inner and outer races rotate freely relative to one another even if the first and second axes are significantly misaligned.

2. The control arm assembly of claim 1, wherein:
the cross member defines opposite ends, and wherein the opposite ends are positioned adjacent the first and second end portions of the arm structure.

3. The control arm assembly of claim 1, wherein:
the rigid arm structure is generally V-shaped.

4. The control arm assembly of claim 1, wherein:
the arm structure includes tubular end portions defining a cylindrical inner surface, and wherein:
the angularly misaligning ball bearings are mounted in the tubular end portions in contact with the cylindrical inner surface.

5. The control arm assembly of claim 4, wherein:
the tubular end portions are welded to the first and second end portions of the rigid arm structure.

6. The control arm assembly of claim 1, wherein:
the rigid arm structure is generally U-shaped.

7. The control arm assembly of claim 1, wherein:
the cross member includes a pair of elongated slots therethrough.

8. The control arm assembly of claim 1, wherein:
the central portion of the arm structure includes a mount adapted to connect to a ball joint.

9. The control arm assembly of claim 1, wherein:
the inner and outer races rotate freely relative to one another even if the first and second axes are misaligned by one degree or more.

10. The control arm assembly of claim 9, wherein:
the inner and outer races rotate freely relative to one another even if the first and second axes are misaligned by five degrees or more.

11. A control arm assembly for a vehicle suspension, comprising:
a substantially rigid arm structure having inner and outer portions, wherein the outer portion includes a mount adapted to connect a ball join to the rigid arm structure;
a mounting member adapted to be fixedly mounted to a vehicle frame structure;
at least one self aligning ball bearing pivotably connecting the rigid arm structure to the mounting member.

12. The control arm assembly of claim 11, wherein:
the rigid arm structure includes front and rear portions extending from the mount.

13. The control arm assembly of claim 12, wherein:
the front and rear portions of the rigid arm structure define outer ends adjacent the mount, and inner ends;
the mounting member extends between the inner ends of the front and rear portions.

14. The control arm assembly of claim 13, wherein:
the rigid arm structure is substantially V or U shaped.

15. The control arm assembly of claim 14, wherein:
the mounting member extends between the inner ends of the front and rear portions of the arm structure.

16. The control arm assembly of claim 15, wherein:
the mounting member defines opposite ends; and wherein:
the at least one self aligning ball bearing comprises a pair of self aligning ball bearings mounted to the opposite ends of the mounting member.

17. The control arm assembly of claim 16, wherein:
the self aligning ball bearings each include inner and outer races that rotate freely relative to one another about a primary axis or rotation.

18. The control arm assembly of claim 17, wherein:
the inner and outer races rotate relative to one another about axes that are transverse relative to the primary axis without restricting rotation of the races about the primary axis.
